(19) United States
(12) Patent Application Publication
(10) Pub. No.: US 2023/0324545 A1
(43) Pub. Date: Oct. 12, 2023

(54) OBJECT DETECTION DEVICE AND OBJECT DETECTION METHOD

(71) Applicant: AISIN CORPORATION, Kariya (JP)

(72) Inventors: Koji NAGASE, Kariya-shi (JP); Hideaki HIROSE, Karita-shi (JP); Eiji ITAMI, Kariya-shi (JP); Kenichi TAGUCHI, Kariya-shi (JP)

(73) Assignee: AISIN CORPORATION, Kariya (JP)

(21) Appl. No.: 18/192,944

(22) Filed: Mar. 30, 2023

(30) Foreign Application Priority Data
Apr. 6, 2022 (JP) 2022-063615

(51) Int. Cl. G01S 13/931; G01S 13/42

(52) U.S. Cl. CPC G01S 13/931; G01S 13/42; G01S 2013/93274

(57) ABSTRACT

An object detection device includes: a position detection unit configured to detect a position of an object outside a vehicle based on sensor information obtained at a predetermined cycle by an object detection sensor mounted on the vehicle; and a determination unit configured to determine whether the object is a moving object based on a time-series amount of change in the position of the object detected by the position detection unit. A first threshold on a lower limit side and a second threshold on an upper limit side are set as thresholds for the amount of change in the position of the moving object. The determination unit determines that the object is a moving object when the amount of change in the position is larger than the first threshold and equal to or smaller than the second threshold.

### CROSS REFERENCE TO RELATED APPLICATIONS

This application is based on and claims priority under 35 U.S.C. § 119 to Japanese Patent Application 2022-063615, filed on Apr. 6, 2022, the entire content of which is incorporated herein by reference.

### TECHNICAL FIELD

Embodiments disclosed here relate to an object detection device and an object detection method.

### BACKGROUND DISCUSSION

In the related art, for example, there has been a technique for calculating a position of an object or the like by transmitting a probe wave (an ultrasonic wave) to the object by an ultrasonic object detection sensor, receiving the probe wave reflected by the object, and performing various calculation.

An object position calculation result is used, for example, to control opening and closing of a door (such as a swing door) of a vehicle. That is, the opening and closing of the door are controlled using the object position calculation result such that the door does not collide with the object. Therefore, the object position calculation result requires high accuracy. It is also important to accurately determine whether the detected object is a moving object (a pedestrian, a vehicle, or the like).

Examples of the related art include JP 2005-76408A (Reference 1), JP 2004-284410A (Reference 2), WO 2009-090696 (Reference 3), and JP 2007-280144A (Reference 4).

However, in the related art described above, there is room for improvement in terms of accuracy in a case of determining whether the detected object is a moving object.

A need thus exists for an object detection device and an object detection method which are not susceptible to the drawback mentioned above.

### SUMMARY

According to an aspect of this disclosure, an object detection device includes: a position detection unit configured to detect a position of an object outside a vehicle based on sensor information obtained at a predetermined cycle by an object detection sensor mounted on the vehicle; and a determination unit configured to determine whether the object is a moving object based on a time-series amount of change in the position of the object detected by the position detection unit. A first threshold on a lower limit side and a second threshold on an upper limit side are set as thresholds for the amount of change in the position of the moving object. The determination unit determines that the object is a moving object when the amount of change in the position is larger than the first threshold and equal to or smaller than the second threshold.

According to another aspect of this disclosure, an object detection method includes, for example: a position detection step of detecting, by a position detection unit, a position of an object outside a vehicle based on sensor information obtained at a predetermined cycle by an object detection sensor mounted on the vehicle; and a determination step of determining, by a determination unit, whether the object is a moving object based on a time-series amount of change in the position of the object detected in the position detection step. In the determination step in which a first threshold on a lower limit side and a second threshold on an upper limit side are set as thresholds for the amount of change in the position of the moving object, the object is determined to be a moving object when the amount of change in the position is larger than the first threshold and equal to or smaller than the second threshold.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a top plan view of a vehicle on which an object detection device according to an embodiment is mounted;

FIG. 2 is a block diagram showing a hardware configuration of the object detection device according to the embodiment;

FIG. 3 is a block diagram showing a functional configuration of the object detection device according to the embodiment;

FIG. 4 is a diagram illustrating a functional outline of a plurality of transmission and reception units according to the embodiment;

FIGS. 5A and 5B are diagrams illustrating a case where a curbstone deviates from a detection region of a sensor due to movement of a door in the embodiment;

FIG. 6A is a flowchart showing a process performed by the object detection device according to the embodiment; and

FIG. 6B is a flowchart showing a process performed by the object detection device according to the embodiment.

### DETAILED DESCRIPTION

Hereinafter, an exemplary embodiment disclosed here will be described. A configuration of the embodiment shown below and actions, results, and effects provided by the configuration are examples. This disclosure can be implemented by configurations other than those disclosed in the following embodiment, and can obtain at least one of various effects based on the basic configuration and derived effects.

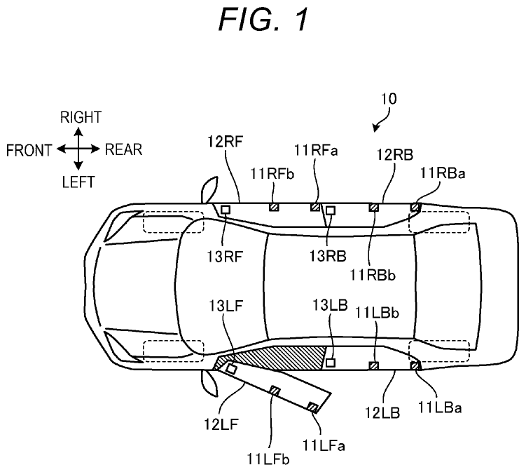

FIG. 1 is a top plan view of a vehicle 10 on which an object detection device according to an embodiment is mounted. Directions indicated by upper left arrows in FIG. 1 are a front direction, a rear direction, a left direction, and a right direction of the vehicle 10.

As shown in FIG. 1, in the vehicle 10 on which an object detection device is mounted, a plurality of transmission and reception units 11RFa, 11RFb, 11RBa, 11RBb, 11LFa, 11LFb, 11LBa, and 11LBb included in the object detection device are provided on, for example, decorative boards of doors 12RF, 12RB, 12LF, and 12LB (swing doors that are opened and closed by rotating about hinges) of the vehicle 10.

The transmission and reception unit 11RFa is provided, for example, in the vicinity of an end portion on an opening and closing end side of the right front door 12RF. A vertical position of the transmission and reception unit 11RFa can be set to a lower position of the door 12RF by fitting the transmission and reception unit 11RFa into a decorative board in a lower portion of the door 12RF. Alternatively, the vertical position of the transmission and reception unit 11RFa may be a central position with respect to upper and lower ends of the door 12RF, a position protruding to an outermost side of the door 12RF, or the like. The transmission and reception unit 11RFb is provided, for example, at a position closer to the front of the vehicle 10 than the transmission and reception unit 11RFa of the door 12RF, and at a predetermined distance from the transmission and reception unit 11RFa. A vertical position of the transmission and reception unit 11RFb is equal to, for example, the vertical position of the transmission and reception unit 11RFa. That is, the transmission and reception unit 11RFb (an example of a first transmission and reception unit) and the transmission and reception unit 11RFa (an example of a second transmission and reception unit) are arranged to be separated by a predetermined distance in a horizontal direction. For example, the transmission and reception units 11LFa and 11LFb are provided at positions corresponding to the transmission and reception units 11RFa and 11RFb of the front left door 12LF, respectively.

The transmission and reception unit 11RBa is provided, for example, in the vicinity of an end portion on an opening and closing end side of the right rear door 12RB. A vertical position of the transmission and reception unit 11RBa can be set to a lower position of the door 12RB by fitting the transmission and reception unit 11RFa into a decorative board in a lower portion of the door 12RB. Alternatively, the vertical position of the transmission and reception unit 11RBa may be a central position with respect to upper and lower ends of the door 12RB, a position protruding to an outermost side of the door 12RB, or the like. The transmission and reception unit 11RBb is provided, for example, at a position closer to the front of the vehicle 10 than the transmission and reception unit 11RBa of the door 12RB, and at a predetermined distance from the transmission and reception unit 11RBa. A vertical position of the transmission and reception unit 11RBb is equal to, for example, the vertical position of the transmission and reception unit 11RBa. That is, the transmission and reception unit 11RBb and the transmission and reception unit 11RBa are arranged at a predetermined distance in the horizontal direction. For example, the transmission and reception units 11LBa and 11LBb are provided at positions corresponding to the transmission and reception units 11RBa and 11RBb of the left rear door 12LB, respectively.

Hereinafter, when not particularly distinguished, the plurality of transmission and reception units 11RFa, 11RFb, 11RBa, 11RBb, 11LFa, 11LFb, 11LBa, and 11LBb are simply referred to as a transmission and reception unit 11 (an object detection sensor) or the like. When not particularly distinguished, the plurality of doors 12RF, 12RB, 12LF, and 12LB are simply referred to as a door 12 or the like.

The transmission and reception unit 11 is a sensor or a sonar that transmits a probe wave such as an ultrasonic wave. The transmission and reception unit 11 also functions as a receiver that receives a probe wave reflected by an object. The transmission and reception unit 11 transmits and receives a probe wave to and from the periphery of the corresponding door 12, thereby detecting an object present in the vicinity of the door 12.

In the vehicle 10 on which the object detection device is mounted, a plurality of door opening degree adjustment units 13RF, 13RB, 13LF, and 13LB included in the object detection device are provided, for example, inside outer panels of the doors 12RF, 12RB, 12LF, and 12LB of the vehicle 10.

The door opening degree adjustment unit 13RF is provided, for example, in the vicinity of an end portion of the right front door 12RF on a hinge side. The door opening degree adjustment unit 13RB is provided, for example, in the vicinity of an end portion of the right rear door 12RB on a hinge side. The door opening degree adjustment unit 13LF is provided, for example, in the vicinity of an end portion of the left front door 12LF on a hinge side. The door opening degree adjustment unit 13LB is provided, for example, in the vicinity of an end portion of the left rear door 12LB on a hinge side.

Hereinafter, when not particularly distinguished, the plurality of door opening degree adjustment units 13RF, 13RB, 13LF, and 13LB are simply referred to as a door opening degree adjustment unit 13 (a drive unit) or the like.

When an object that may be an obstacle is present in the vicinity of any one of the doors 12, the door opening degree adjustment unit 13 adjusts an opening degree of the corresponding door 12 to avoid a collision between the door 12 and the object.

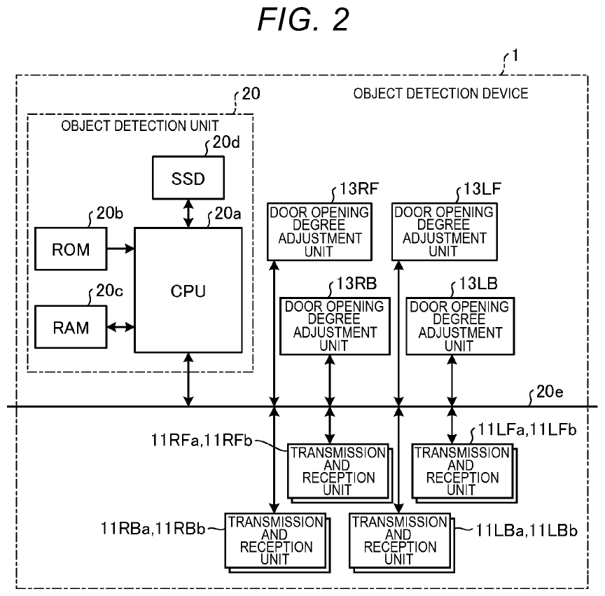

FIG. 2 is a block diagram showing a hardware configuration of the object detection device 1 according to the embodiment. The object detection device 1 detects an object around each door 12 of the vehicle 10 based on a reception result or the like obtained by the transmission and reception unit 11. When an object that may be an obstacle is detected, the object detection device 1 avoids a collision with the object by the door opening degree adjustment unit 13.

As shown in FIG. 2, the object detection device 1 includes the plurality of transmission and reception units 11RFa, 11RFb, 11RBa, 11RBb, 11LFa, 11LFb, 11LBa, and 11LBb, the plurality of door opening degree adjustment units 13RF, 13RB, 13LF, and 13LB, an object detection unit 20, and an in-vehicle network 20e.

The plurality of transmission and reception units 11 are connected to the in-vehicle network 20e, and transmit transmission and reception information to the object detection unit 20 via the in-vehicle network 20e. The plurality of door opening degree adjustment units 13 are connected to the in-vehicle network 20e, and receive control from the object detection unit 20 via the in-vehicle network 20e to adjust the opening degree of each door 12.

The object detection unit 20 determines the presence of the object, a position of the object, and the like based on the transmission and reception information acquired from each of the plurality of transmission and reception units 11. The object detection unit 20 outputs information on the detected object to the door opening degree adjustment unit 13 to avoid a collision with the door 12.

The object detection unit 20 is a computer including a microcomputer such as an electronic control unit (ECU). The object detection unit 20 includes a central processing unit (CPU) 20a, a read only memory (ROM) 20b, a random access memory (RAM) 20c, and a solid state drive (SSD) 20d. The CPU 20a, the ROM 20b, and the RAM 20c may be integrated into the same package.

The CPU 20a is an example of a hardware processor, reads a program stored in a non-volatile storage device such as the ROM 20b, and executes various calculation and control in accordance with the program.

The ROM 20b stores programs, parameters required for execution of the programs, and the like. The RAM 20c temporarily stores various types of data used in the calculations performed by the CPU 20a. The SSD 20d is a rewritable non-volatile storage device, and maintains data even when the object detection unit 20 is powered off.

The in-vehicle network 20e is, for example, a controller area network (CAN). The in-vehicle network 20e electrically connects the plurality of transmission and reception units 11, the plurality of door opening degree adjustment units 13, and the object detection unit 20 such that signals and information can be transmitted and received.

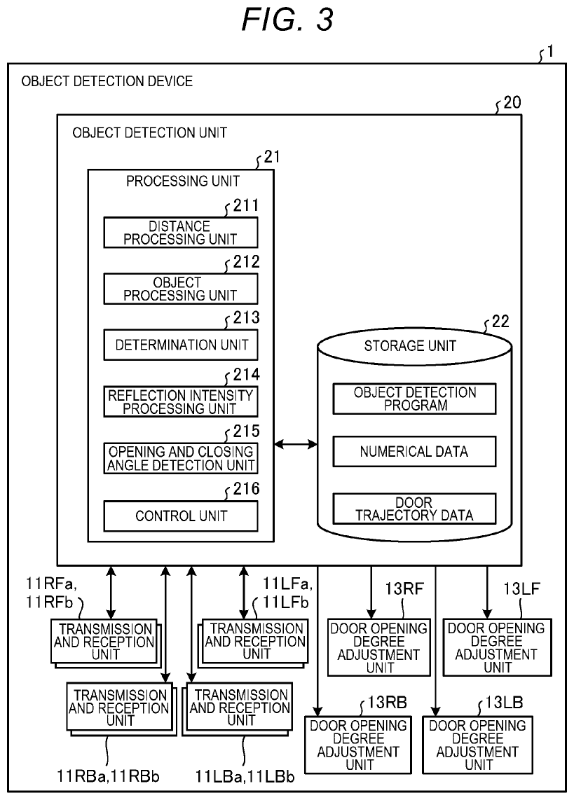

FIG. 3 is a block diagram showing a functional configuration of the object detection device 1 according to the embodiment. As shown in FIG. 3, the object detection unit 20 of the object detection device 1 includes a processing unit 21 and a storage unit 22.

The storage unit 22 stores a program executed by the processing unit 21 and data necessary for executing the program. For example, the storage unit 22 stores an object detection program executed by the processing unit 21. The storage unit 22 stores numerical data necessary for executing the object detection program. The storage unit 22 stores door trajectory data and the like necessary for executing the object detection program.

The processing unit 21 calculates the position of the object based on reception results obtained by the plurality of transmission and reception units 11. The processing unit 21 is implemented as, for example, a function of the CPU 20a. The processing unit 21 includes a distance processing unit 211, an object processing unit 212, a determination unit 213, a reflection intensity processing unit 214, an opening and closing angle detection unit 215, and a control unit 216. The processing unit 21 functions as each of the units 211 to 216 by reading the object detection program stored in the storage unit 22, for example. Some or all of the units 211 to 216 may be implemented by hardware such as a circuit including an application specific integrated circuit (ASIC) or a field-programmable gate array (FPGA) or the like.

Hereinafter, among the plurality of transmission and reception units 11, the transmission and reception units 11RFa and 11RFb will be mainly taken as examples when the description is based on examples, and the same applies to the other transmission and reception units 11 as well.

The distance processing unit 211 calculates a first point based on a reception result obtained by the transmission and reception unit 11RFa and a reception result obtained by the transmission and reception unit 11RFb when the transmission and reception unit 11RFa transmits a probe wave, and calculates a second point based on the reception result obtained by the transmission and reception unit 11RFa and the reception result obtained by the transmission and reception unit 11RFb when the transmission and reception unit 11RFb transmits a probe wave. The distance processing unit 211 calculates a separation distance between the first point and the second point. The distance processing unit 211 determines whether the separation distance is equal to or greater than a predetermined separation distance threshold.

The object processing unit 212 (a position detection unit) determines the position, an outer shape, and the like of the object based on information calculated by the distance processing unit 211. The object processing unit 212 detects the position of the object outside the vehicle 10 based on sensor information obtained by the transmission and reception unit 11 at a predetermined cycle (for example, about several tens to several hundreds of milliseconds). Specifically, for example, the object processing unit 212 calculates the position of the object based on the first point and the second point. The object processing unit 212 determines whether the object has a wall shape or a pole shape in accordance with the separation distance between the first point and the second point.

The determination unit 213 executes various determination. The determination unit 213 determines whether the object is a moving object based on, for example, a time-series amount of change in the position of the object detected by the object processing unit 212. For example, a first threshold on a lower limit side and a second threshold on an upper limit side are set as thresholds for an amount of change in the position of the moving object. The first threshold is set, for example, as a value slightly smaller than a normal amount of change in the case where the object is a pedestrian. The second threshold is set, for example, as a value slightly larger than a maximum value of the amount of change considered in the case where the object is a pedestrian. However, values of the first threshold and the second threshold are not limited thereto.

For example, when the amount of change in the position is larger than the first threshold and equal to or less than the second threshold, the determination unit 213 determines that the object is a moving object. This is because in this case, there is a high possibility that the object is a moving object such as a pedestrian. The determination unit 213 may determine that the object is a moving object when the number of times the amount of change in the position is larger than the first threshold and equal to or smaller than the second threshold reaches a predetermined number of times equal to or larger than two. Thus, determination accuracy is further improved.

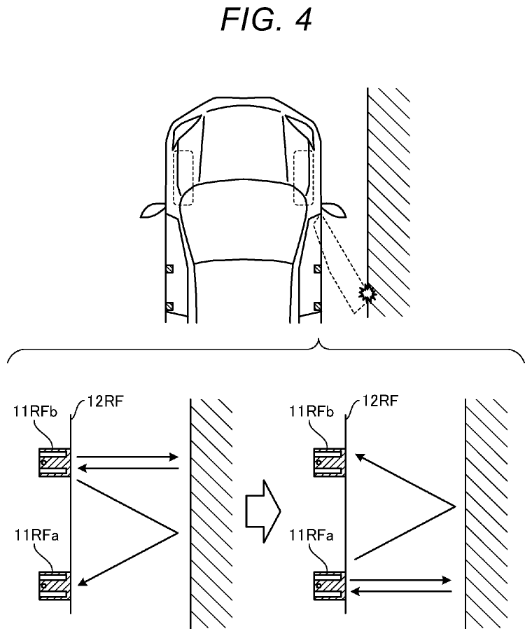

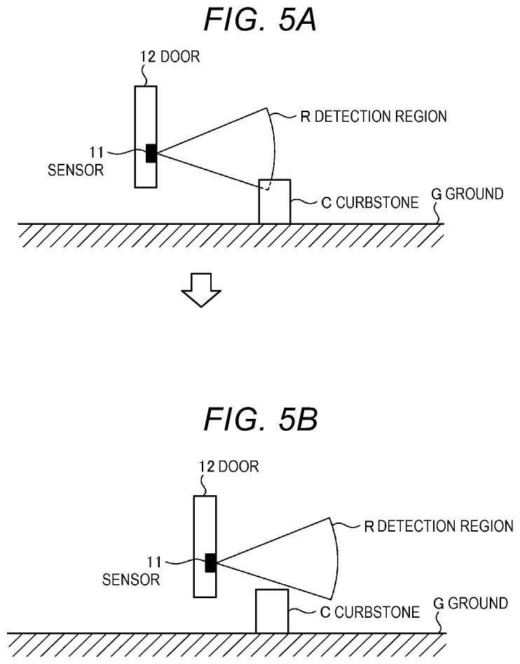

When the amount of change in the position is larger than the second threshold or when the position is undetectable, the determination unit 213 determines that the object is not a moving object. This will be described with reference to FIGS. 4 and 5.

FIG. 4 is a diagram illustrating a functional outline of the plurality of transmission and reception units 11 according to the embodiment. As shown in FIG. 4, each of the plurality of transmission and reception units 11 is configured to radially transmit a probe wave toward the outside of the door 12 and receive a probe wave directed to the transmission and reception unit 11 per se. At this time, among the plurality of transmission and reception units 11, the transmission and reception units 11 provided on the same door 12 are configured to be paired and interlocked. For example, two transmission and reception units 11RFa and 11RFb provided on the door 12RF shown in FIG. 4 cooperate with each other. Accordingly, an object in the vicinity of the door 12RF is detected.

Specifically, the transmission and reception units 11RFa and 11RFb alternately repeat a period in which the probe wave is transmitted and received and a period in which the probe wave is only received. At this time, the transmission and reception unit 11RFa transmits and receives the probe wave in a period in which the transmission and reception unit 11RFb receives the probe wave. The transmission and reception unit 11RFa only receives the probe wave in a period in which the transmission and reception unit 11RFb transmits and receives the probe wave. The transmission and reception unit 11RFb transmits and receives the probe wave in a period in which the transmission and reception unit 11RFa receives the probe wave. The transmission and reception unit 11RFb only receives the probe wave in a period in which the transmission and reception unit 11RFa transmits and receives the probe wave. Hereinafter, the transmission and reception unit 11 is also referred to as a sensor 11.

For example, due to the movement of the door 12 on which the sensor 11 is installed, a curbstone that has been detected before may deviate from a detection region of the sensor 11 during the period. FIGS. 5A and 5B are diagrams illustrating a case where a curbstone C deviates from a detection region R of the sensor 11 due to the movement of the door 12 in the embodiment.

In FIG. 5A, the curbstone C on a ground G enters the detection region R of the sensor 11. After that, it is assumed that the door 12 on which the sensor 11 is installed approaches the curbstone C by an opening operation. Then, as shown in FIG. 5B, the curbstone C may deviate from the detection region R of the sensor 11.

If the detection region R of the sensor 11 is directed further downward, such a possibility can be reduced, but in this case, the ground G may be detected as an object, so such a measure has limitations. Therefore, in order to cope with such a case, the determination unit 213 determines that the object is not a moving object when the position of the object suddenly becomes undetectable. That is, it is assumed that a low object such as a curbstone exists, instead of a moving object moving and disappearing.

Conversely, when the door 12 performs a closing operation, the curbstone C, which has not been detected before, may be suddenly detected. Therefore, in order to deal with such a case, the determination unit 213 determines that the object is not a moving object when the amount of change in the position is larger than the second threshold. That is, it is assumed that a low object such as a curbstone originally existed, instead of a moving object moving at high speed.

Referring back to FIG. 3, the reflection intensity processing unit 214 calculates a reflection intensity representing an intensity of probe waves received by the transmission and reception unit 11RFa and the transmission and reception unit 11RFb. The reflection intensity processing unit 214 determines whether the reflection intensity is equal to or larger than a predetermined reflection intensity threshold. Accordingly, it is possible to distinguish whether an object or noise is detected.

The opening and closing angle detection unit 215 detects an opening and closing angle of the door 12 based on predetermined sensor information or the like.

The control unit 216 executes various control. The control unit 216 controls, for example, the door opening degree adjustment unit 13 that drives opening and closing of the door 12. The determination unit 213 and the control unit 216 cooperate to control the opening and closing of the door 12 while preventing the door 12 from coming into contact with (colliding with) the object. This will be described in detail below.

When the determination unit 213 determines that a moving object is moving in a direction toward the door 12, the determination unit 213 calculates a distance between the moving object and the door 12 and a movement speed or a movement vector (a movement speed and a movement direction) of the moving object. Further, based on this information and a current opening and closing angle of the door 12 detected by the opening and closing angle detection unit 215, the determination unit 213 calculates a contact opening and closing angle, which is an opening and closing angle at which the moving object and the door 12 are predicted to come into contact with each other.

Specifically, for example, the determination unit 213 determines whether an object exists in a region surrounded by a fully closed position of the door 12, a fully opened position of the door 12, and a trajectory when the door 12 is opened and closed. When the object exists in the region, the determination unit 213 calculates a contact position between the object and the door 12, and calculates the contact opening and closing angle which is the opening and closing angle corresponding to the contact position.

In this case, the control unit 216 controls the door opening degree adjustment unit 13 such that the door 12 stops when the door 12 performs an opening operation corresponding to an angle smaller than the contact opening and closing angle by a predetermined angle.

When the determination unit 213 determines that a moving object is moving in a direction away from the door 12, the determination unit 213 calculates the movement speed of the moving object. In this case, the control unit 216 controls the door opening degree adjustment unit 13 such that the opening and closing speed of the door 12 is smaller than the movement speed.

When the determination unit 213 determines that an object is not a moving object, the determination unit 213 calculates a distance between a previously detected (in the previous cycle) position of the object and the door 12. In this case, the control unit 216 controls the door opening degree adjustment unit 13 such that the door 12 does not come into contact with the object based on the distance.

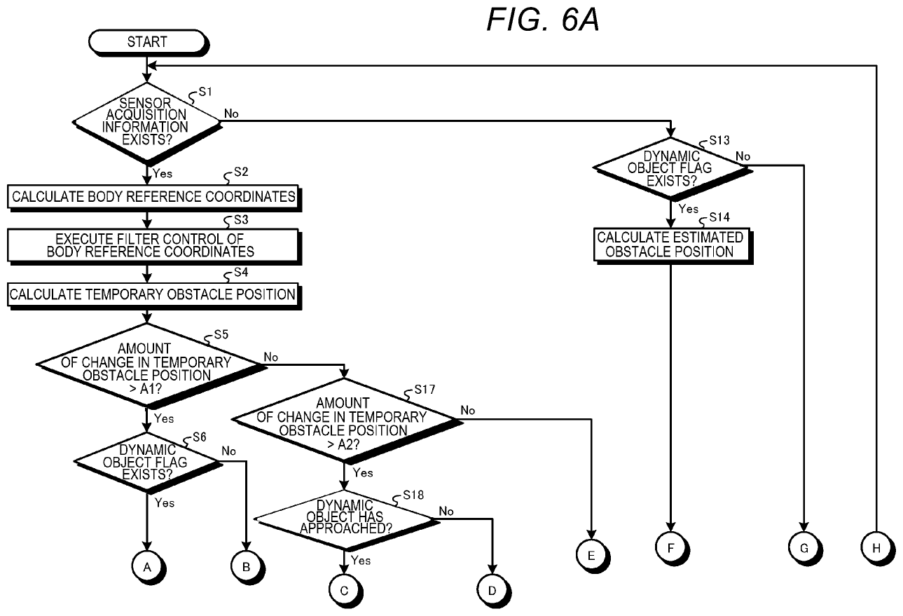

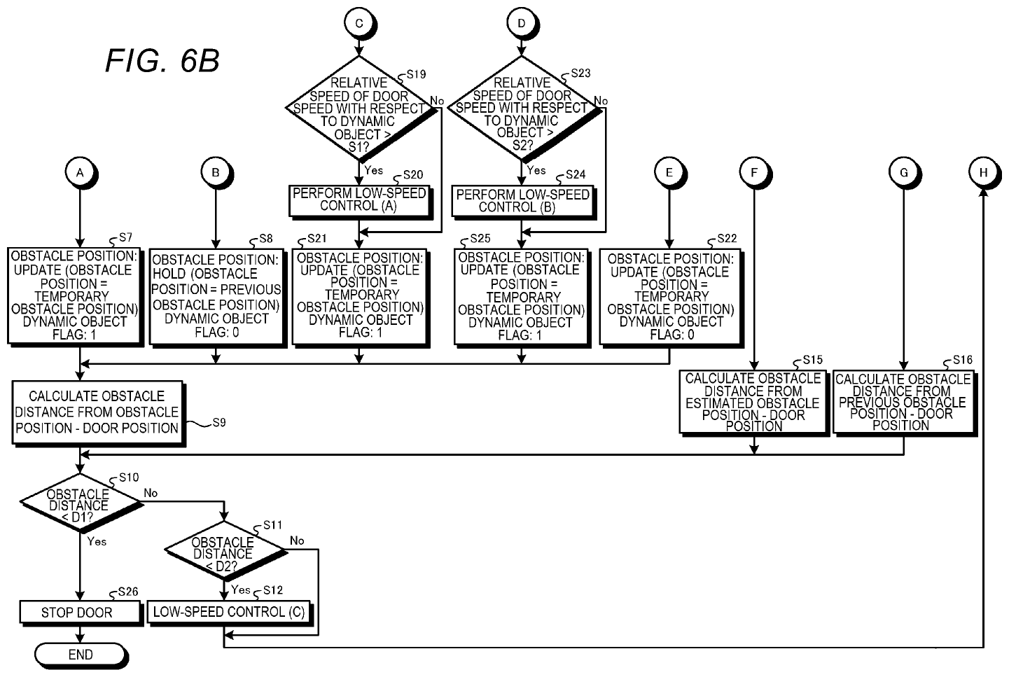

Next, processes performed by the object detection device will be described with reference to FIGS. 6A and 6B. FIGS. 6A and 6B are flowcharts showing processes performed by the object detection device according to the embodiment. This series of processes is executed, for example, at a cycle of several milliseconds to several tens of milliseconds. Acquisition of sensor information by the sensor 11 is executed in a period longer than the period, for example, a cycle of several tens of milliseconds to several hundreds of milliseconds. Among the opening operation and closing operation of the door 12, this process is related to the opening operation.

In step S1, the processing unit 21 determines whether sensor acquisition information exists. The process proceeds to step S2 if Yes, and proceeds to step S13 if No.

In step S2, the processing unit 21 calculates body reference coordinates. That is, since the sensor information is the sensor reference coordinates based on an installation position of the sensor 11, the sensor information on the sensor reference coordinates is converted into body reference coordinates based on a position of a body of the vehicle 10.

Next, in step S3, the processing unit 21 executes filter control of the body reference coordinates. In this filter control, for example, removal of noise, removal of data out of a trajectory range of the door 12, extraction of information with high reflection energy, and the like are executed.

Next, in step S4, the object processing unit 212 calculates the position of the object as a temporary obstacle position.

Next, in step S5, the determination unit 213 determines whether an amount of change in the temporary obstacle position (a difference between a current value and a previous value) is larger than A1 (the second threshold). The process proceeds to step S6 if Yes, and proceeds to step S17 if No. When the position of the object suddenly becomes undetectable, a result in step S5 is also Yes.

In step S6, the determination unit 213 determines whether a dynamic object flag exists, and proceeds to step S7 if Yes (the dynamic object flag is “1” (a flag indicating that the object is a dynamic object (a moving object))), and proceeds to step S8 if No (the dynamic object flag is “0” (a flag indicating that the object is not a dynamic object (a moving object))).

In step S7, the determination unit 213 updates an obstacle position with the temporary obstacle position and sets the dynamic object flag to “1”. Thereafter, the process proceeds to step S9.

In step S8, the determination unit 213 sets the obstacle position by holding a previous obstacle position, and sets the dynamic object flag to “0”. Thereafter, the process proceeds to step S9.

In step S17, the determination unit 213 determines whether the amount of change of the temporary obstacle position is larger than A2 (the first threshold). The process proceeds to step S18 if Yes, and proceeds to step S22 if No.

In step S18, the determination unit 213 determines whether a dynamic object is moving in a direction toward the door 12. The process proceeds to step S19 if Yes, and proceeds to step S23 if No.

In step S19, the determination unit 213 determines whether a relative speed of the door 12 with respect to the dynamic object is larger than a relative speed threshold S1 (a threshold for approaching). The process proceeds to step S20 if Yes, and proceeds to step S21 if No.

In step S20, the control unit 216 performs low-speed control (A) in relation to the opening operation of the door 12. The low-speed control (A) is control for moving the door 12 at a lower speed than normal. A degree of the low-speed may be determined according to a predetermined ratio, or may be determined according to a relative speed between the door 12 and the dynamic object. Thereafter, the process proceeds to step S21.

In step S21, the determination unit 213 updates the obstacle position with the temporary obstacle position and sets the dynamic object flag to “1”. Thereafter, the process proceeds to step S9.

In step S23, the determination unit 213 determines whether the relative speed of the door 12 with respect to the dynamic object is larger than a relative speed threshold S2 (a threshold for separation). The process proceeds to step S24 if Yes, and proceeds to step S25 if No.

In step S24, the control unit 216 performs low-speed control (B) in relation to the opening operation of the door 12. A degree of the low-speed may be determined according to the predetermined ratio, or may be determined according to a relative speed between the door 12 and the dynamic object. Thereafter, the process proceeds to step S25.

In step S25, the determination unit 213 updates the obstacle position with the temporary obstacle position and sets the dynamic object flag to “1”. Thereafter, the process proceeds to step S9.

In step S22, the determination unit 213 updates the obstacle position with the temporary obstacle position and sets the dynamic object flag to “0”. Thereafter, the process proceeds to step S9.

In step S13, the determination unit 213 determines whether the dynamic object flag exists. The process proceeds to step S14 if Yes (the dynamic object flag is “1”), and proceeds to step S16 if No (the dynamic object flag is “0”).

In step S14, the object processing unit 212 calculates an estimated obstacle position in consideration of movement of the object.

Next, in step S15, the distance processing unit 211 calculates an obstacle distance (a distance to the obstacle) by calculating a difference between the estimated obstacle position and a position of the door 12. Thereafter, the process proceeds to step S10.

In step S16, the distance processing unit 211 calculates an obstacle distance by calculating a difference between the previous obstacle position and the position of the door 12. Thereafter, the process proceeds to step S10.

In step S9, the distance processing unit 211 calculates an obstacle distance by calculating a difference between the obstacle position and the position of the door 12. Thereafter, the process proceeds to step S10.

In step S10, the determination unit 213 determines whether the obstacle distance is less than a distance threshold D1 (for example, about 10 cm). The process proceeds to step S26 if Yes, and proceeds to step S11 if No.

In step S26, the control unit 216 controls the door opening degree adjustment unit 13 to stop the door 12.

In step S11, the determination unit 213 determines whether the obstacle distance is less than a distance threshold D2 (for example, about 30 cm). The process proceeds to step S12 if Yes, and returns to step S1 if No.

In step S12, the control unit 216 performs low-speed control (C) in relation to the opening operation of the door 12. That is, when the obstacle distance is less than the distance threshold D1 (for example, about 10 cm), the door 12 is stopped, but before that, the low-speed control (C) is performed after the obstacle distance is less than the distance threshold D2 (for example, about 30 cm). A degree of the low-speed may be determined according to the predetermined ratio, or may be determined according to a distance or the relative speed between the dynamic object and the door 12. Thereafter, the process returns to step S1.

A flow of the series of processes for each object will be described. For example, when the object is a walking person, the dynamic object flag is set to “1” in the previous step S21 or step S25.

A result in step S5 is No, and a result in step S17 is Yes. When the person is moving at a high speed in a direction toward the door 12, since a result in step S19 is Yes, the low-speed control (A) is performed in step S20, and it is possible to reduce the possibility that the person and the door 12 come into contact with each other.

When the person is moving at a low speed in a direction away from the door 12, since a result in step S23 is Yes, the low-speed control (B) is performed in step S24, and it is possible to reduce the possibility that the door 12 catches up with and comes into contact with the person.

For example, when the object is a curbstone, the dynamic object flag is “0” in the previous step S22. When the position of the curbstone suddenly becomes undetectable, the result in step S5 is Yes, and a result in step S6 is No. By setting the obstacle position by holding the previous obstacle position in step S8, a subsequent process can be performed based on a correct position of the curbstone. Accordingly, it is possible to reduce the possibility that the door 12 comes into contact with the curbstone due to erroneous recognition that no curbstone exists.

Thus, according to the present embodiment, it is possible to determine whether the detected object is a moving object with high accuracy by determining that the object is a moving object when the amount of change in the position of the object is larger than the first threshold and equal to or smaller than the second threshold. That is, for example, taking a person and a curbstone as an example, the object is determined as a person when distance information changes step by step or changes within a certain threshold, and the object is determined as a curbstone rather than a person when the distance information changes instantaneously or changes beyond the certain threshold.

In addition, it is possible to determine whether the detected object is a moving object with high accuracy by setting a condition that the number of times the amount of change in the position is larger than the first threshold and equal to or smaller than the second threshold reaches a predetermined number of times equal to or larger than two as a condition for determining that the object is a moving object.

When the object detection sensor installed on the door 12 of the vehicle 10 moves together with the movement of the door 12 and a position of a low object such as a curbstone suddenly becomes undetectable, or the like, it is possible to determine that the object is not a moving object with high accuracy. Accordingly, the door 12 can perform the opening operation without contacting the curbstone. That is, by using a previously detected high-accuracy position of the curbstone, it is possible to reduce the possibility that the door 12 comes into contact with the object.

By the low-speed control (B) in step S24, it is possible to reduce the possibility that the door 12 catches up with and comes into contact with an object moving at a low speed in a direction away from the door 12.

In the related art, the possibility of contact between the door 12 and the object increases since data on the sensor 11 can be acquired only at discrete sampling cycles. However, according to the present embodiment, by performing the low-speed control (A) to (C) under a predetermined condition, it is possible to reduce the possibility of the contact between the door 12 and the object.

In the related art, when a reflected wave of the probe wave is detected, since it is determined that the reflected wave is detected not when a value of a detection signal starts to increase but when the value of the detection signal reaches the threshold, the possibility of the contact between the door 12 and the object increases due to time error corresponding to that amount. However, according to the present embodiment, by performing the low-speed controls (A) to (C) under a predetermined condition, it is possible to reduce the possibility of the contact between the door 12 and the object.

Since the position of the object can be detected with high accuracy by the series of processes described above, for example, even when the object is a moving object, it is possible to reduce the possibility that an operation of the door 12 is stopped when the door 12 is far from the moving object, and to stop the door 12 with high accuracy at an appropriate position before reaching the object.

Even for a low object such as a curbstone, the possibility that the object comes into contact with the door 12 can be reduced without requiring a change in the arrangement of the sensors 11 or an increase in the number of the sensors 11.

Although the embodiment disclosed here has been described above, the above embodiment and the modification are merely examples, and the scope disclosed here is not intended to be limited. The above embodiment and the modification can be carried out in various other forms, and various omissions, replacements, combinations, and changes can be made without departing from the scope disclosed here. The configurations and shapes of the respective embodiments and the modification can be partly exchanged.

For example, in the above-described embodiment, the object detection unit 20 includes one ECU, but is not limited thereto. The object detection unit 20 may include a plurality of ECUs. At this time, one ECU may perform some functions of the object detection unit 20, and another ECU may perform other functions of the object detection unit 20.

In the above-described embodiment, one door 12 is provided with two transmission and reception units 11, but is not limited thereto. For example, when a millimeter wave radar is used as the object detection sensor, each door 12 may be provided with one millimeter wave radar.

A movement vector (movement speed, movement direction) of an obstacle may be obtained, and when the obstacle moves in an unintended vector direction, the obstacle may be determined to be a dynamic object.

In the above-described embodiment, for example, a dynamic object is determined in a two-dimensional plane of XY coordinates, and when the object detection sensor is, for example, a millimeter wave radar and can obtain three-dimensional information on an object, a dynamic object may be determined in a three-dimensional space of XYZ coordinates. Accordingly, by using information related to height direction in object detection, it is possible to prevent erroneous detection of an animal (a cat or the like) that is sufficiently lower than the door 12.

An object to be detected is not limited to the above described object such as a person, a curbstone, or the like, and may be a wall, a bicycle, a utility pole, or the like.

When a person is assumed as a moving object, a near distance measurement technique such as a smart key or an ultra wide band (UWB) may be utilized to improve accuracy. When a UWB is used, for example, a UWB application may be installed in a smartphone owned by a driver, a distance between a smartphone and the vehicle 10 may be measured, and a measurement result may be utilized.

In the above-described embodiment, a target on which the sensor 11 is installed is the vehicle 10, but is not limited thereto. The target on which the sensor 11 is installed is an overall mobile object such as a mobile robot around which the environment changes from moment to moment according to the movement.

According to an aspect of this disclosure, an object detection device includes: a position detection unit configured to detect a position of an object outside a vehicle based on sensor information obtained at a predetermined cycle by an object detection sensor mounted on the vehicle; and a determination unit configured to determine whether the object is a moving object based on a time-series amount of change in the position of the object detected by the position detection unit. A first threshold on a lower limit side and a second threshold on an upper limit side are set as thresholds for the amount of change in the position of the moving object. The determination unit determines that the object is a moving object when the amount of change in the position is larger than the first threshold and equal to or smaller than the second threshold.

With this configuration, it is possible to determine whether the detected object is a moving object with high accuracy by determining that the object is a moving object when the amount of change in the position is larger than the first threshold and equal to or smaller than the second threshold.

In the object detection device, for example, the determination unit determines that the object is a moving object when the number of times the amount of change in the position is larger than the first threshold and equal to or smaller than the second threshold reaches a predetermined number of times equal to or larger than two.

With this configuration, it is possible to determine whether the detected object is a moving object with high accuracy by setting a condition that the number of times the amount of change in the position is larger than the first threshold and equal to or smaller than the second threshold reaches a predetermined number of times equal to or larger than two as a condition for determining that the object is a moving object.

In the object detection device, for example, the object detection sensor is installed in a swing door of the vehicle. The determination unit determines that the object is not a moving object when the amount of change in the position is larger than the second threshold or when the position is undetectable.

With this configuration, for example, even when the object detection sensor installed on the door of the vehicle moves together with movement of the door, and a position of a low object such as a curbstone suddenly becomes undetectable, it is possible to determine that the object is not a moving object with high accuracy.

In the object detection device, for example, the object detection sensor is installed in a swing door of the vehicle. The object detection device further includes an opening and closing angle detection unit configured to detect an opening and closing angle of the door, and a control unit configured to control a drive unit that drives opening and closing of the door. When the determination unit determines that the moving object is moving in a direction toward the door, the determination unit calculates a distance between the moving object and the door and a movement speed or a movement vector of the moving object, and calculates a contact opening and closing angle, which is an opening and closing angle at which the moving object and the door are predicted to come into contact with each other, based on a current opening and closing angle detected by the opening and closing angle detection unit. The control unit controls the drive unit such that the door stops when the door performs an opening operation corresponding to an angle smaller than the contact opening and closing angle by a predetermined angle.

With this configuration, the door can perform the opening operation without contacting the object.

In the object detection device, for example, when the determination unit determines that the moving object is moving in a direction away from the door, the determination unit calculates the movement speed of the moving object, and the control unit controls the drive unit such that an opening and closing speed of the door is smaller than the movement speed.

With this configuration, it is possible to reduce the possibility that the door catches up with and comes into contact with the object moving the direction away from the door.

In the object detection device, for example, when the determination unit determines that the object is not a moving object, the determination unit calculates a distance between a previously detected position of the object and the door, and the control unit controls the drive unit such that the door does not come into contact with the object based on the distance.

With this configuration, when it is determined that the object is not a moving object, by using a previously detected high-accuracy position of the object, it is possible to reduce the possibility that the door comes into contact with the object.

According to another aspect of this disclosure, an object detection method includes, for example: a position detection step of detecting, by a position detection unit, a position of an object outside a vehicle based on sensor information obtained at a predetermined cycle by an object detection sensor mounted on the vehicle; and a determination step of determining, by a determination unit, whether the object is a moving object based on a time-series amount of change in the position of the object detected in the position detection step. In the determination step in which a first threshold on a lower limit side and a second threshold on an upper limit side are set as thresholds for the amount of change in the position of the moving object, the object is determined to be a moving object when the amount of change in the position is larger than the first threshold and equal to or smaller than the second threshold.

With this configuration, it is possible to determine whether the detected object is a moving object with high accuracy by determining that the object is a moving object when the amount of change in the position is larger than the first threshold and equal to or smaller than the second threshold.

For example, the object detection sensor is installed in a swing door of the vehicle. The determination step includes, when the moving object is determined to be moving in a direction toward the door, calculating a distance between the moving object and the door and a movement speed or a movement vector of the moving object, and calculating a contact opening and closing angle, which is an opening and closing angle at which the moving object and the door are predicted to come into contact with each other, based on a current opening and closing angle detected by an opening and closing angle detection unit that detects an opening and closing angle of the door. The object detection method further includes a control step of controlling, by a control unit, a drive unit that drives opening and closing of the door such that the door stops when the door performs an opening operation corresponding to an angle smaller than the contact opening and closing angle by a predetermined angle.

With this configuration, the door can perform the opening operation without contacting the object.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An object detection device comprising:
a position detection unit configured to detect a position of an object outside a vehicle based on sensor information obtained at a predetermined cycle by an object detection sensor mounted on the vehicle; and
a determination unit configured to determine whether the object is a moving object based on a time-series amount of change in the position of the object detected by the position detection unit, wherein
a first threshold on a lower limit side and a second threshold on an upper limit side are set as thresholds for the amount of change in the position of the moving object, and
the determination unit determines that the object is a moving object when the amount of change in the position is larger than the first threshold and equal to or smaller than the second threshold.

2. The object detection device according to claim 1, wherein
the determination unit determines that the object is a moving object when the number of times the amount of change in the position is larger than the first threshold and equal to or smaller than the second threshold reaches a predetermined number of times equal to or larger than two.

3. The object detection device according to claim 1, wherein
the object detection sensor is installed in a swing door of the vehicle, and
the determination unit determines that the object is not a moving object when the amount of change in the position is larger than the second threshold or when the position is undetectable.

4. The object detection device according to claim 1, wherein
the object detection sensor is installed in a swing door of the vehicle,
the object detection device further includes:
an opening and closing angle detection unit configured to detect an opening and closing angle of the door; and
a control unit configured to control a drive unit that drives opening and closing of the door,
when the determination unit determines that the moving object is moving in a direction toward the door, the determination unit calculates a distance between the moving object and the door and a movement speed or a movement vector of the moving object, and calculates a contact opening and closing angle, which is an opening and closing angle at which the moving object and the door are predicted to come into contact with each other, based on a current opening and closing angle detected by the opening and closing angle detection unit, and
the control unit controls the drive unit such that the door stops when the door performs an opening operation corresponding to an angle smaller than the contact opening and closing angle by a predetermined angle.

5. The object detection device according to claim 4, wherein
when the determination unit determines that the moving object is moving in a direction away from the door, the determination unit calculates the movement speed of the moving object, and
the control unit controls the drive unit such that an opening and closing speed of the door is smaller than the movement speed.

6. The object detection device according to claim 4, wherein
when the determination unit determines that the object is not a moving object, the determination unit calculates a distance between a previously detected position of the object and the door, and
the control unit controls the drive unit such that the door does not come into contact with the object based on the distance.

7. The object detection device according to claim 5, wherein
when the determination unit determines that the object is not a moving object, the determination unit calculates a distance between a previously detected position of the object and the door, and
the control unit controls the drive unit such that the door does not come into contact with the object based on the distance.

8. An object detection method comprising:
a position detection step of detecting, by a position detection unit, a position of an object outside a vehicle based on sensor information obtained at a predetermined cycle by an object detection sensor mounted on the vehicle; and
a determination step of determining, by a determination unit, whether the object is a moving object based on a time-series amount of change in the position of the object detected in the position detection step, wherein
a first threshold on a lower limit side and a second threshold on an upper limit side are set as thresholds for the amount of change in the position of the moving object, and
in the determination step, the object is determined to be a moving object when the amount of change in the position is larger than the first threshold and equal to or smaller than the second threshold.

9. The object detection method according to claim 8, wherein
the object detection sensor is installed in a swing door of the vehicle,
the determination step includes, when the moving object is determined to be moving in a direction toward the door, calculating a distance between the moving object and the door and a movement speed or a movement vector of the moving object, and calculating a contact opening and closing angle, which is an opening and closing angle at which the moving object and the door are predicted to come into contact with each other, based on a current opening and closing angle detected by an opening and closing angle detection unit that detects an opening and closing angle of the door, and
the object detection method further includes a control step of controlling, by a control unit, a drive unit that drives opening and closing of the door such that the door stops when the door performs an opening operation corresponding to an angle smaller than the contact opening and closing angle by a predetermined angle.
